(19) United States
(12) Patent Application Publication
(10) Pub. No.: US 2008/0023237 A1
(43) Pub. Date: Jan. 31, 2008

(54) Hybrid Drive Train Provided with Hub Motors

(76) Inventor: Martin Houle, Laval (CA)

Correspondence Address: FAY KAPLUN & MARCIN, LLP, 15O BROADWAY, SUITE 702, NEW YORK, NY, 10038, US

(21) Appl. No.: 11/573,372

(22) PCT Filed: Sep. 1, 2005
(86) PCT No.: PCT/CA05/01340

§ 371 Date: Jul. 30, 2007

(51) Int. Cl. B60K 6/26; B60L 11/14

(52) U.S. Cl. 180/65.2; 464/109; 903/902

(57) ABSTRACT

A parallel hybrid drive train is provided with an internal combustion engine (ICE) that supplies mechanical power to two driving wheels of a vehicle. Each driving wheel is provided with a respective hub motor having a stator mounted to the vehicle and a rotor directly connected to the driving wheel. The interconnection between the ICE and the driving wheel is done via a cardan joint provided between the output shaft of the ICE and each driving wheel. Accordingly, when the hub motors are energized, the drive train is in a parallel hybrid mode where both the ICE and the hub motors contribute to the rotation of the wheel. The drive train may also be placed in a conventional mode when the hub motors are not energized and in a purely electric mode when the ICE is not running.

### FIELD OF THE INVENTION

The present invention relates to hybrid drive trains. More specifically, the present invention is concerned with a hybrid drive train provided with electric hub motors in the driving wheels of a vehicle.

### BACKGROUND OF THE INVENTION

Vehicles having a hybrid drive train are well known in the art. They are usually provided with an internal combustion engine (ICE) and an electric traction motor that may transfer power to at least one traction wheel of the vehicle.

A hybrid drive train is said to be a parallel hybrid drive train when both the traction motor and the ICE may be used simultaneously or individually to transfer power to the wheels of the vehicle. In parallel hybrid drive trains, the ICE may also be used to recharge batteries of the vehicle through an electric generator. Some hybrid drive trains are purely parallel and some may selectively be changed from a parallel to a serial configuration.

Early parallel hybrid drive included electric motors associated with the rear wheels and an ICE associated with the front wheels. This arrangement has the drawback of taking much space in the vehicle.

### OBJECTS OF THE INVENTION

An object of the present invention is therefore to provide an improved hybrid drive train provided with hub motors.

### SUMMARY OF THE INVENTION

More specifically, in accordance with a first aspect of the present invention, there is provided a hybrid drive train for a vehicle provided with at least one driving wheel, the drive train comprising: at least one hub motor associated with a respective one of the at least one driving wheel; each the at least one hub motor being provided with a stator mounted to the vehicle and a rotor secured to the respective one of the at least one driving wheel; and an engine provided with a rotatable output shaft; the rotatable output shaft being operatively coupled to the respective one of the at least one driving wheel.

According to a second aspect of the present invention, there is provided a hub motor for a driving wheel part of a vehicle provided with a hybrid drive train, the hybrid drive train including an engine provided with a rotatable output shaft, the hub motor comprising: a stator mounted to the vehicle; a rotor; and a coupling element for interconnecting the rotor with the driving wheel, and for interconnecting the rotatable output shaft with both the rotor and the driving wheel.

According to a third aspect of the present invention, there is provided a coupling element for interconnecting a rotor of a hub motor to a driving wheel in a hybrid drive train, the hybrid drive train further comprising an engine provided with an output shaft, the coupling element comprising: a first interconnecting portion for interconnection with the driving wheel; a second interconnecting portion for interconnection with the output shaft; and a third interconnecting portion for interconnection with the rotor.

According to a fourth aspect of the present invention, there is provided a hybrid drive train for a vehicle provided with first and second driving wheels, the drive train comprising: an internal combustion engine (ICE) provided with an output shaft; first and second hub motors each associated with a respective driving wheel; each the first and second hub motors being provided with a stator and a rotor; the stator being mounted to the vehicle and the rotor being mounted to a respective driving wheel; a first cardan joint assembly interconnecting the output shaft and the first driving wheel; and a second cardan joint assembly interconnecting the output shaft and the second driving wheel; wherein a) when the hub rotor is energized, the drive train is placed in a parallel hybrid driving mode and b) when the hub motor is not energized, the drive train is in a conventional driving mode.

Other objects, advantages and features of the present invention will become more apparent upon reading of the following non-restrictive description of preferred embodiments thereof, given by way of example only with reference to the accompanying drawings.

It is to be noted that the expression “hub motor” is to be construed herein as a either a conventional hub motor, a motor-wheel, or any other electric motor configuration where at least part of the device is mounted in close proximity of the driving wheel of the vehicle.

### BRIEF DESCRIPTION OF THE DRAWINGS

In the appended drawings:

FIG. 1 is a schematic view of a parallel hybrid drive train according to an illustrative embodiment of the present invention;

FIG. 2 is a sectional view of a traction wheel provided with a hub motor used in the parallel hybrid drive train of FIG. 1; and

FIG. 3 is a close-up view of the hub motor of FIG. 1.

### DETAILED DESCRIPTION

Generally stated, the present invention is concerned with a hybrid drive train provided with a central internal combustion engine (ICE) that conventionally supplies mechanical power to driving wheels of a vehicle. Each driving wheel is provided with a respective hub motor having a stator mounted to the vehicle and a rotor directly connected to the driving wheel. The interconnection between the ICE and the driving wheel is done via the rotor of the hub motor. For example, a cardan joint assembly is provided between the output shaft of the ICE and each rotor of the hub motors. Accordingly, when the hub motors are energized, the drive train is in a parallel hybrid mode where both the ICE and the hub motors contribute to the rotation of the wheel. The drive train may also be placed in a conventional mode where the hub motors are not energized and in a purely electric mode when the ICE is not running.

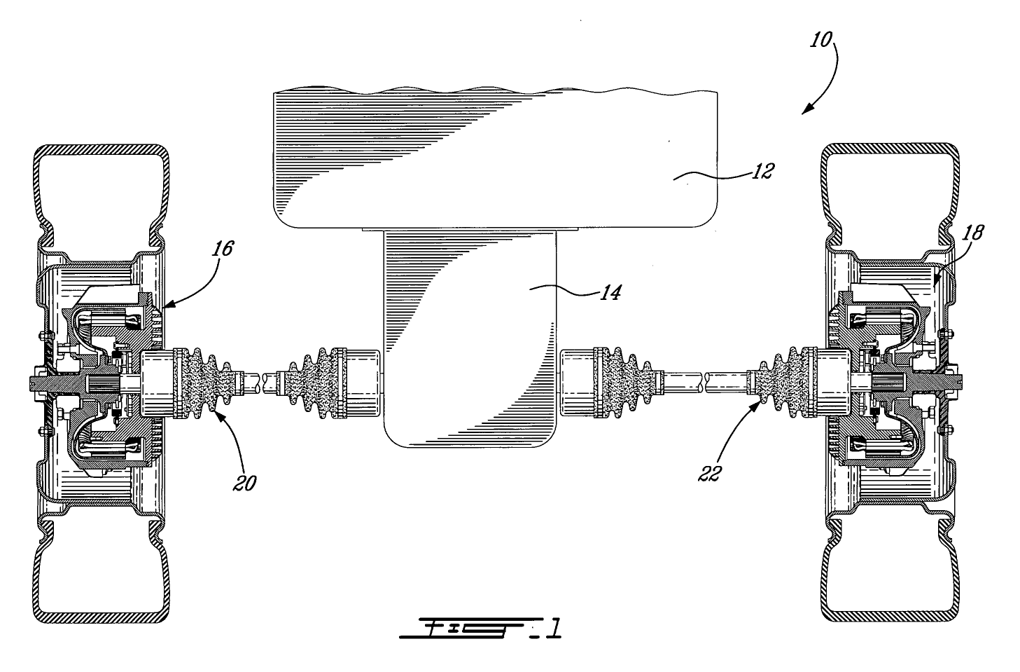

Turning now to FIG. 1 of the appended drawings, a hybrid drive train 10 according to an embodiment of the present invention will be described. The drive train 10 includes an ICE 12 provided with a transmission 14, two driving wheels 16 and 18 interconnected to the transmission 14 via respective cardan joint assemblies 20 and 22. The driving wheels 16 and 18 are therefore indirectly connected to the output shaft (not shown) of the ICE 12.

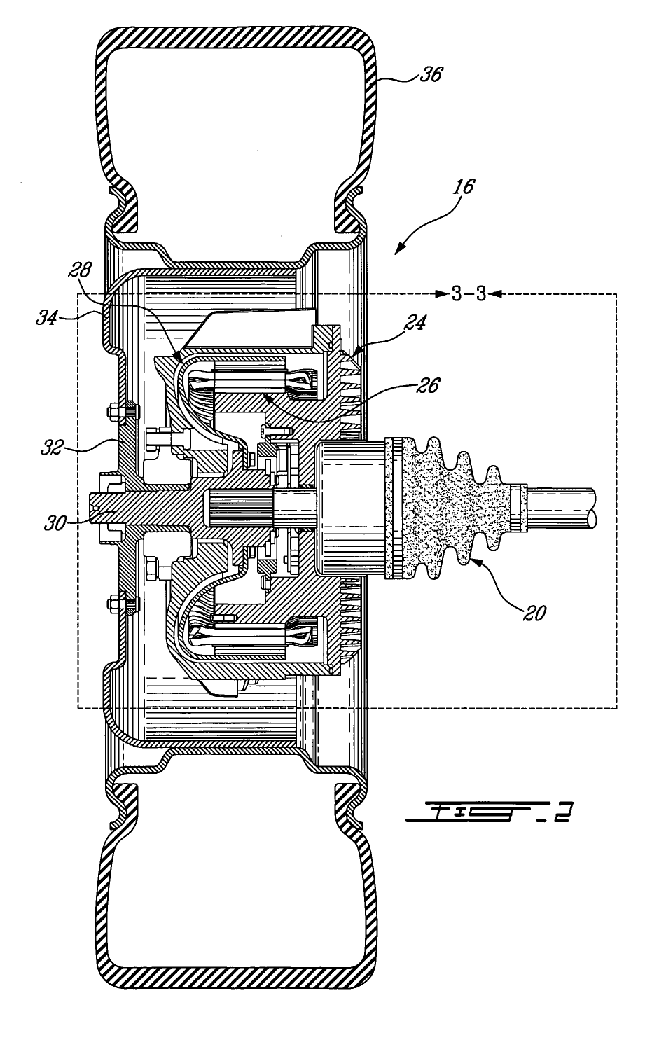

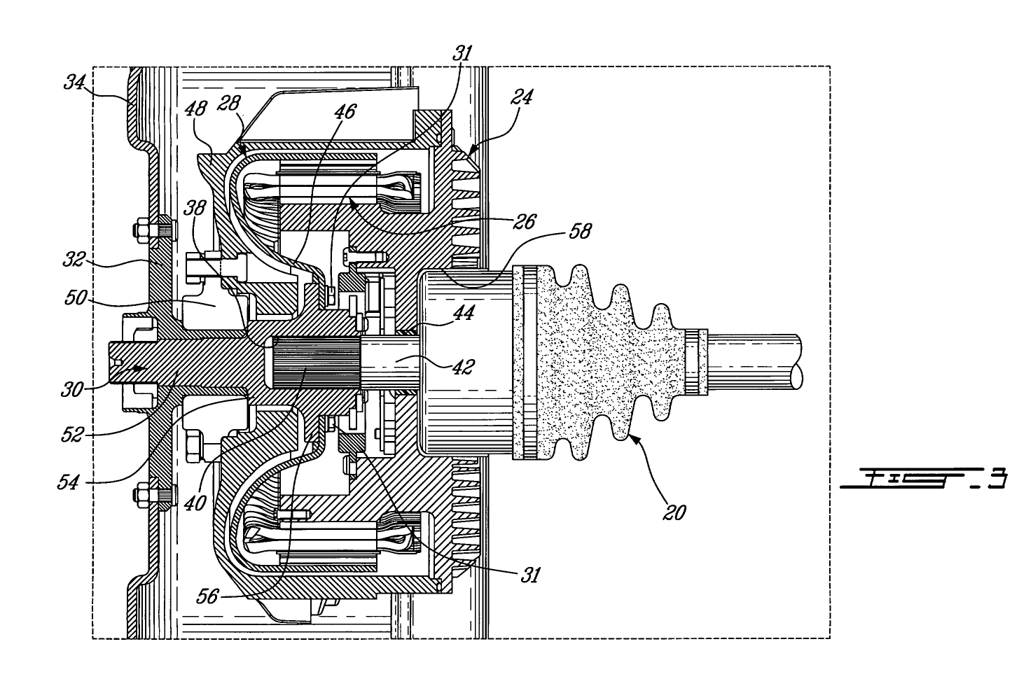

Turning now more specifically to FIGS. 2 and 3 of the appended drawings, the driving wheel 16 of the parallel hybrid drive train 10 will be described. It is to be noted that since the driving wheels 16 and 18 are identical, only the driving wheel 16 will be described in details hereinbelow.

The driving wheel 16 includes a hub motor 24 provided with a stator 26 and a rotor 28. A coupling element 30 is mounted to the rotor 28 via fastening means in the form of fasteners 31 and supports a hub 32 to which a rim 34 is mounted. A tire 36 is mounted to the rim 34. Other fastening means, such as welding may also be used to secure the coupling element 31 to the rotor 28.

FIG. 3 is a close-up view of the hub motor of FIG. 2. As can be better seen from this figure, the coupling element 30 includes a spined aperture 38 so configured and sized as to receive a spined portion 40 of the shaft 42 of the cardan joint assembly 20. The cardan joint assembly 20 is partly supported by a seal 44 provided between the cardan joint assembly 20 and the hub motor 24. As will now become more apparent the coupling element 30 further interconnects the output shaft of the ICE 12 to both the driving wheel 16 and the rotor 28 via the cardan joint assembly 20.

The hub motor 24 is of the external rotor type, i.e. the rotor 28 is concentric with the stator 26 but is externally mounted. A curved wall 46 joins the rotor 28 and the coupling element 30.

The coupling element 30 is in the form of an elongated body having a first interconnecting generally cylindrical portion 52 to snuggly complement the hub 32 and a second interconnecting portion 54 extending longitudinally from the first portion and including the spined aperture to receive the spined portion 40 of the shaft 42. The coupling element further includes a peripheral flange 56, extending from the second portion, to receive the fasteners 31. The hub motor 24 is also configured so as to include a recessed portion 58 for receiving part of the cardan joint assembly 20 so as to increase the interconnection between the cardan joint assembly 20 and the hub motor 24.

It is to be noted that the longitudinal position of the peripheral flange may vary.

The coupling element 30 may have other configuration allowing interconnecting the rotor 28 with the driving wheel 16, and for interconnecting the shaft 42 with both the rotor 28 and the driving wheel 16.

It is believed that the operation of electric motors in general and more specifically of hub motors are well known by those skilled in the art and will therefore not be further described herein.

The rotor 28 and stator 26 are covered by a casing 48 that encloses the motor 24 and also supports bearings 50.

Three operational driving mode of the parallel hybrid drive train 10 will now be described.

In a first conventional driving mode, the ICE 12 is energized, causes the rotation of the cardan joint assemblies 20 and 22 to thereby drive the driving wheels 16 and 18. While the drive train 10 is in this mode, the hub motors 24 (only one shown) are not energized and their respective rotors 28 (only one shown) are freewheeling.

In a second hybrid driving mode, the ICE 12 is energized, causes the rotation of the cardan joint assemblies 20 and 22 to thereby drive the driving wheels 16 and 18. While the drive train 10 is in this mode, the hub motors 24 (only one shown) are energized and their respective rotors 28 (only one shown) are rotated both via their direct connection to the cardan joint assembly 20 and by the electric current flowing through the stator 26. Accordingly, both the ICE 12 and the hub motors 24 are used to drive the driving wheels 16 and 18.

In a third electric driving mode, the ICE 12 is not energized. While the drive train 10 is in this mode, the hub motors 24 (only one shown) are energized and their respective rotors 28 (only one shown) are rotated via the electric current flowing through the stator 26.

It is also to be noted that even though an external rotor type hub motor has been illustrated as supplying electric power to the driving wheels, other types of motors such as, for example, more conventional internal rotor electric motor or other types of motor-wheel technologies could be used.

One skilled in the art will understand that the interconnection between the cardan joint assembly and the wheel could be different than the one illustrated without departing from the present invention. For example, the end of the cardan joint could be conventionally secured to the wheel via a fastener and the rotor of the motor could be associated with the wheel while the stator is associated with the chassis of the vehicle.

It is to be noted that even though the above description is concerned with a vehicle having two driving wheels, the present invention could be used with a vehicle having four driving wheels. The present invention can also be used without a cardan joint assembly, wherein, the coupling element directly receives the output shaft of an ICE. The present invention can also then be used in vehicle provided with a single hub motor.

The present invention is not limited to hybrid drive trains including an ICE. Any other type of engine can alternatively be provided to transfer power to the driving wheels in parallel to the hub motors.

It is finally to be noted that the coupling element 30 can be part of the hub motor 24, an extension of the cardan joint assembly, or simply an independent part of the hybrid drive train.

Although the present invention has been described hereinabove by way of preferred embodiments thereof, it can be modified, without departing from the spirit and nature of the subject invention as defined in the appended claims.

What is claimed is:

1. A hybrid drive train for a vehicle provided with at least one driving wheel, the drive train comprising:
at least one hub motor associated with a respective one of said at least one driving wheel; each said at least one hub motor being provided with a stator mounted to the vehicle and a rotor secured to said respective one of said at least one driving wheel; and
an engine provided with a rotatable output shaft; said rotatable output shaft being operatively coupled to said respective one of said at least one driving wheel.

2. A hybrid drive train as recited in claim 1, further comprising at least one cardan joint assembly; each of said at least one cardan joint assembly interconnecting a respective one of said rotor with said rotatable output shaft.

3. A hybrid drive train as recited in claim 2, further comprising a transmission interconnecting said rotatable output shaft with said at least one cardan joint assembly.

4. A hybrid drive train as recited in claim 3, wherein said at least one cardan joint assembly is partly supported by a seal provided between said at least one cardan joint assembly and said at least one hub motor.

5. A hybrid drive train as recited in claim 2, wherein said at least one hub motor includes a recessed portion for receiving part of said at least one cardan joint assembly, thereby increasing the interconnection therebetween.

6. A hybrid drive train as recited in claim 1, further comprising:
a coupling element interconnecting said rotor with said respective one of said at least one driving wheel, and interconnecting said rotatable output shaft with both said rotor and said respective one of said at least one driving wheel.

7. A hybrid drive train as recited in claim 6, further comprising at least one cardan joint assembly interconnecting a respective one of said rotor with said rotatable output shaft via said coupling element.

8. A hybrid drive train as recited in claim 7, wherein said at least one cardan joint assembly comprises a spined output shaft; said coupling element including a spined aperture for receiving said spined output shaft.

9. A hybrid drive train as recited in claim 6, wherein said coupling element is in the form of an elongated body having:
a first interconnecting portion for interconnection with said at least one driving wheel;
a second interconnecting portion for interconnection with the rotatable output shaft; and
a third interconnecting portion for interconnection with the rotor.

10. A hybrid drive train as recited in claim 9, wherein said at least one driving wheel includes a hub and a rim mounted to said hub; said first interconnecting portion being generally cylindrical for snuggly complementing said hub.

11. A hybrid drive train as recited in claim 9, wherein said second interconnecting portion extends from said first interconnecting portion towards said rotatable output shaft.

12. A hybrid drive train as recited in claim 9, wherein said third interconnecting portion includes a peripheral flange extending from one of said first and second interconnecting portions for fastening to said rotor.

13. A hybrid drive train as recited in claim 6, wherein said coupling element is secured to said rotor via fasteners.

14. A hybrid drive train as recited in claim 2, wherein said at least one hub motor includes two hub motors; said at least one cardan joint assembly including two cardan joint assemblies; each of said two hub motors being mounted to said rotatable output shaft via a respective one of said two cardan joint assemblies.

15. A hybrid drive train as recited in claim 1, wherein said at least one hub motor is of the external rotor type.

16. A hybrid drive train as recited in claim 1, wherein said engine is an internal combustion engine (ICE).

17. A hybrid drive train as recited in claim 1, wherein, in operation in a conventional driving mode, said engine is energized thereby causing a rotation of said rotatable output shaft, thereby driving said at least one driving wheel; said at least one hub motor not being energized and said rotor being freewheeling.

18. A hybrid drive train as recited in claim 1, wherein, in operation in a hybrid driving mode, said engine is energized thereby causing a rotation of said rotatable output shaft, thereby driving said at least one driving wheel; said at least one hub motor being energized yielding a current flowing through said stator causing a further rotation of said rotor; said rotation of said rotor causing a rotation of said driving wheel.

19. A hybrid drive train as recited in claim 1, wherein, in operation in an electric driving mode, said engine is not energized; said at least one hub motor being energized yielding a current flowing through said stator causing a rotation of said rotor; said rotation of said rotor causing a rotation of said driving wheel.

20. A hybrid drive train as recited in claim 1, further comprising a casing enclosing said rotor and stator.

21. A hub motor for a driving wheel part of a vehicle provided with a hybrid drive train, the hybrid drive train including an engine provided with a rotatable output shaft, the hub motor comprising:
a stator mounted to the vehicle;
a rotor; and
a coupling element for interconnecting said rotor with the driving wheel, and for interconnecting the rotatable output shaft with both said rotor and said driving wheel.

22. A hub motor as recited in claim 21, wherein said coupling element is secured to said rotor via fasteners.

23. A hub motor as recited in claim 22, wherein said engine is an internal combustion engine (ICE).

24. A hub motor as recited in claim 22, further comprising a casing enclosing said rotor and stator.

25. A coupling element for interconnecting a rotor of a hub motor to a driving wheel in a hybrid drive train, the hybrid drive train further comprising an engine provided with an output shaft, the coupling element comprising:
a first interconnecting portion for interconnection with the driving wheel;
a second interconnecting portion for interconnection with the output shaft; and
a third interconnecting portion for interconnection with the rotor.

26. A coupling element as recited in claim 25, wherein said driving wheel includes a hub and a rim mounted to said hub; said first interconnecting portion being generally cylindrical for snuggly complementing said hub.

27. A coupling element as recited in claim 25, wherein said second interconnection portion allows for interconnection with said output shaft via a cardan joint assembly.

28. A coupling element as recited in claim 27, wherein said cardan joint assembly comprises a spined output shaft; said second interconnecting portion including a spined aperture for receiving said spined output shaft.

29. A coupling element as recited in claim 28, wherein said cardan joint assembly is partly supported by a seal provided between said cardan joint assembly and the hub motor.

30. A coupling element as recited in claim 25, wherein said third coupling element includes a peripheral flange extending from one of said first and second interconnecting portions for fastening to said rotor.

31. A hybrid drive train for a vehicle provided with first and second driving wheels, said drive train comprising:
an internal combustion engine (ICE) provided with an output shaft;
first and second hub motors each associated with a respective driving wheel; each said first and second hub motors being provided with a stator and a rotor; said stator being mounted to the vehicle and said rotor being mounted to a respective driving wheel;
a first cardan joint assembly interconnecting said output shaft and said first driving wheel; and
a second cardan joint assembly interconnecting said output shaft and said second driving wheel;
wherein a) when said hub rotor is energized, the drive train is placed in a parallel hybrid driving mode and b) when said hub motor is not energized, said drive train is in a conventional driving mode.
